(19) United States
(12) Patent Application Publication
(10) Pub. No.: US 2004/0213495 A1
(43) Pub. Date: Oct. 28, 2004

(54) Fire safe bearings

(75) Inventor: Lars Kahlman, Partille (SE)

Correspondence Address: BURNS DOANE SWECKER & MATHIS L L P, POST OFFICE BOX 1404, ALEXANDRIA, VA, 22313-1404, US

(73) Assignee: Aktiebolaget SKF, Goteborg (SE)

(21) Appl. No.: 10/780,680

(22) Filed: Feb. 19, 2004

(30) Foreign Application Priority Data
Feb. 20, 2003 (SE) 0300471-0

(51) Int. Cl. F16C 41/00; F16C 19/00

(52) U.S. Cl. 384/624

(57) ABSTRACT

The present invention refers to a bearing and lubricant combination for use as a supporting system for a rotating shaft in a smoke and heat exhaust ventilation system and having properties permitting it to fulfill the requirement to withstand an emergency temperature of 600° C. for at least 60 minutes, with a stand-still of 2 minutes after 15 minutes exposure to the emergency temperature, wherein the bearing is a martensitic stainless bearing (rings) with a steel cage; and which bearing is lubricated with an electric motor grease with a base oil viscosity in the region of 50-200 cSt at 40° C.

This application is based on and claims priority under 35 U.S.C. § 119 with respect to Swedish Application No. 0300471-0 filed on Feb. 20, 2003, the entire content of which is incorporated herein by reference.

### FIELD OF THE INVENTION

The present invention relates to fire safe bearings, and particularly deep groove ball bearings for fans and electric motors.

### BACKGROUND OF THE INVENTION

Good fire protection of large-scale building works such as tunnels for transports, airports, warehouses, large public buildings etc is today regarded as an essential practice. Since 15-20 years many of these structures have been equipped with powered smoke and heat exhaust ventilation systems (SHEVS). These SHEVS ensure introduction of cooler and cleaner air below hot gases in cases of fires. However, these SHEVS should also give end-users low operating cost, as these systems are in continuous daily use for comfort ventilation.

A new European standard (EN 12101-3) is under introduction. The standard specifies that electric motors used in ventilators should be classified in classes up to 600° C. (Table 1). The new standard is a harmonization of old country standards but with the important additional requirement of a two-minute standstill period at the emergency temperature.

TABLE 1

| | | Required | |
|---|---|---|---|
| | | running | |
| | | time at | Requirement of |
| | Emergency | emergency | standstill period at |
| Emergency | temperature | temperature | emergency |
| class | (° C.) | (minutes) | temperature |
| F200 | 200 | 120 | 2 min after 15 min |
| | | | at emergency |
| | | | temp. |
| F300 | 300 | 60 | 2 min after 15 min |
| | | | at emergency |
| | | | temp. |
| F400 | 400 | 120 | 2 min after 15 min |
| | | | at emergency |
| | | | temp. |
| F600 | 600 | 60 | 2 min after 15 min |
| | | | at emergency |
| | | | temp. |

It can be noted that the standard leaves to the manufacturers and end-users to ensure low life cycle cost for the operation of the SHEVS as daily comfort ventilators. The below requirements, given by the standard (I-II), but also additional customer needs are required (III-IV):

I. Emergency running capability at 400° C. (2 hrs) and 600° C. (Ihr), according to standard;

II. Shutdown and restart capability, at emergency temperature, according to standard;

III. Very long service-life (grease-life) at normal motor temperatures (70-120° C.): and

IV. Low noise at normal working temperatures.

V. Low cost

Today, the certified electric motors for SHEVS use bearings of harden bearing steels (typically an AISI 52100 carbon chromium steel containing approximately 1% carbon and 1.5% chromium) and they are lubricated with high temperature greases or pastes based on silicone or PTFE thickeners and base oils. Often the bearings are also subjected to special heat treatment (stabilization) to secure that structural changes do not occur at higher temperatures (often up to about 200-250° C.). However, these bearing types do not fulfill the requirements I and II of the standard for F600 motors and, most important, they do not have a good behaviour with reference to requirements III and IV.

### SUMMARY OF THE INVENTION

There is provided a bearing and lubricant combination for use as a supporting system for a rotating shaft in a smoke and heat exhaust ventilation system and having properties permitting it to fulfill the requirement to withstand an emergency temperature of 600° C. for at least 60 minutes with a stand-still of 2 minutes after 15 minutes exposure to the emergency temperature comprising a bearing comprising marterisitic stainless steel bearing rings with a steel cage, which bearing is lubricated with an electric motor grease with a base oil viscosity in the region of 50-200 cSt at 40° C.

### BRIEF DESCRIPTION OF THE DRAWINGS

The foregoing and additional features and characteristics of the present invention will become more apparent from the following detailed description considered with reference to the accompanying drawing figures.

FIG. 1 is a graphical representation of the test results of various bearing and lubricant combinations at various times and temperatures.

FIG. 2 is a drawing in partial cutaway view of a typical deep groove ball bearing.

### DETAILED DESCRIPTION OF THE INVENTION

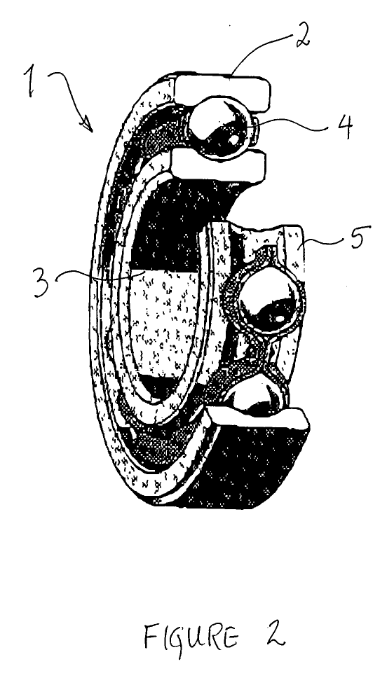

A typical deep groove ball bearing is shown in FIG. 2 in which the ball bearing 1 has an outer race ring 2 and an inner race ring 3 (both made of marterisitic steel) between which are arranged a number of balls 4 spaced apart and guided in a steel cage 5. Other types of deep groove bearings are known and encompassed herein.

Based on the above-mentioned requirements it was anticipated from earlier experiences (e.g. SKF Evolution magazine 2/96, “Evaluating hybrid bearings for general applications”) that hybrid bearings (bearings with AISI 52100 steel rings and silicon nitride ceramic rolling elements) lubricated with long-life electric machinery grease would give the required (I-IV) performances for F400 and F600 motors. However, hybrid bearings would have difficulties to fulfill the low cost requirement (V) to enable broad acceptance.

A screening test was constructed to compare these hybrid bearings with other bearings ability to perform according to the standard for the motors.

### EXAMPLE 1

### Screen Test

Eight setups (sixteen bearings) with different 6205 deep grove ball bearing designs (ring and cage materials) and lubricants (greases) were selected to be tested (Table 2). Tests were carried out stepwise in sequence according to 100° C. (2 hours run in); 200° C. (1 hours); 300° C. (1 hours); 400° C. (1 hours); 600° C. (1 hours); or until failure.

Test procedures: 15 min. at temperature/stop and standstill 2 mm./45 min. at temperatures.

Running Conditions:

Axial load (Fₐ): 190 N

Radial load (Fᵣ): 350 N

Speed: 1500 rpm

Grease volume for (normal fill) 6205 bearing: about 1.8 cm³

TABLE 2

| Variant | Bearing materials | Grease |
|---|---|---|
| A. | Hybrid bearing (martensitic | Klüber Asonic GHY |
| | stainless | 72 |
| | steel rings); steel cage | |
| B. | Hybrid bearing (AISI 52100 | Klüber Asonic GHY |
| | bearing | 72 |
| | steel rings); steel cage | |
| C. | All-stainless (martensitic) steel | Klüber Asonic GHY |
| | bearings (rings and balls); steel | 72 |
| | cage | |
| D. | All-steel(AISO 52100) bearing; | Klüber Barrier at |
| | steel | L55/2 |
| | cage | |
| E. | All-steel (AISI 52100) bearing; | Dow Corning |
| | steel | Molykote 41 |
| | cage | |
| F. | All-steel (AISI 52100) bearing; | Klüber Asonic GHY |
| | steel | 72 |
| | cage | |
| G. | All-steel (AISI 52100) bearing, | FT150 bearings from |
| | rings | SNR; PTFE grease |
| | temperature stabilized to | |
| | 150° C.; steel | |
| | cage | |
| H. | Hybrid bearing with AISI 52100 | Klüber Asonic GHY |
| | bearing steel rings and | 72 |
| | polyamide | |
| | cage | |

Klüber Asonic GHY 72 grease-Electric motor grease, low noise, long life in 70-120° C. interval (polyurea soap; synthetic ester base oil; and base oil viscosity approximately 72 cSt at 40 ° C.)

Klüber Barrier at L5512 grease—PTFE based high temperature grease

Dow Corning Molykote 41 grease—Silicone based high temperature grease

Results of Screen Test

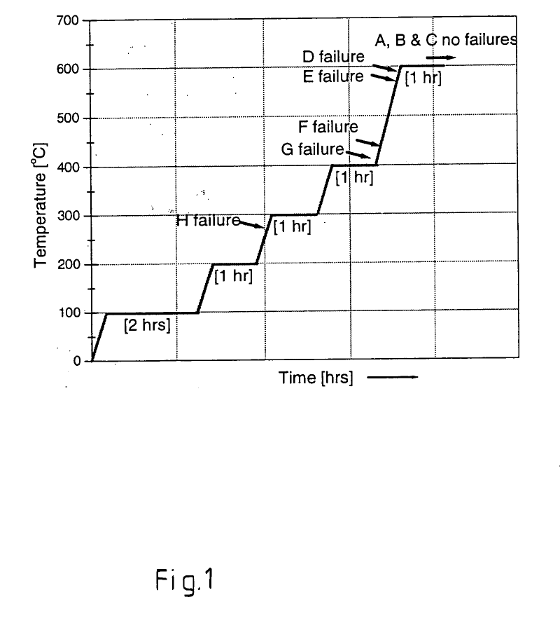

As expected, the two hybrid bearing variants (A and B) survived the total cycle of the screen test. However, an all-stainless steel variant C (martensitic stainless steel X65Cr 13) with a conventional electric machinery grease did, surprisingly, outperform all other all-steel variants, even those with high temperature greases, and showed the same level of survivability as the two hybrid bearing variants. This enables, unexpectedly, the fulfilling of the low cost requirement (V) and fulfilling of the safety function. The screen test results are shown in the accompanying FIG. 1 for deep groove ball bearings (designation 6205) for use in motors of smoke and heat exhaust ventilation systems. The other test samples D-H appearing in the test failed before reaching the test temperature.

The invention is not limited to the combination as described in the description, but modifications and variants are possible within the scope of the attached claims.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A bearing and lubricant combination for use as a supporting system for a rotating shaft in a smoke and heat exhaust ventilation system and having properties permitting it to fulfill the requirement to withstand an emergency temperature of 600° C. for at least 60 minutes with a stand-still of 2 minutes after 15 minutes exposure to the emergency temperature comprising a bearing comprising martensitic stainless steel bearing rings with a steel cage, which bearing is lubricated with an electric motor grease with a base oil viscosity in the region of 50-200 cSt at 40° C.

2. The bearing and lubricant combination of claim 1 wherein the grease comprises a soap of polyurea.

3. The bearing and lubricant combination of claim 1 wherein the grease comprises a base oil of synthetic ester.

4. The bearing and lubricant combination of claim 1 wherein the bearing is a deep groove ball bearing.
